(19) United States
(12) Patent Application Publication
(10) Pub. No.: US 2018/0035008 A1
(43) Pub. Date: Feb. 1, 2018

(54) Image Forming Method That Ensures High Speed Monochrome Printing

(71) Applicant: Kyocera Document Solutions Inc., Osaka (JP)

(72) Inventor: Xuqiang Bai, Rancho Palos Verdes, CA (US)

(21) Appl. No.: 15/224,662

(22) Filed: Jul. 31, 2016

(51) Int. Cl. H04N 1/40; G06F 3/12; G06K 15/02; H04N 1/60

(52) U.S. Cl. CPC H04N 1/40012; H04N 1/6005; G06F 3/1297; G06K 15/1802; H04N 2201/0082

(57) ABSTRACT

An image forming method comprising includes: receiving print data; detecting whether the received print data includes specific encoded data where a luminance component is encoded separately from chrominance components; generating monochrome data by decoding the luminance component without decoding the chrominance components if the specific encoded data is detected and execution of the monochrome printing is determined; and executing monochrome printing based on the monochrome data.

### BACKGROUND

Unless otherwise indicated herein, the description in this section is not prior art to the claims in this application and is not admitted to be prior art by inclusion in this section.

This disclosure is related with a Postscript color conversion in printer RIP system. Postscript is one of page description languages (PDL) to describe print jobs. Postscript print jobs include image data and commands. The image data in Postscript are often compressed by encoders (also called filters) in order to reduce data size when transferring from host computers to printers. Regarding image data in Postscript, when generating print jobs in host computers, encoders encode image data into encoded image data for print jobs; when printer RIP system received print jobs, decoders decode the encoded image data in the print jobs in order to print it out.

Among those encoders and decoders, there is a pair of encoder and decoder named as Discrete Cosine Transform (DCT). When generating Postscript print jobs, the DCT encoder converts image data to YUV or YUVK color space first and then executes DCT encoding. When decoding in printer RIP, typical methods decode YUV or YUVK first, convert YUV to RGB or convert YUVK to CMYK, and then if it is monochrome printing, convert image data to grayscale from input color space.

### SUMMARY

An image forming method according to one aspect of the disclosure includes: receiving print data; detecting whether the received print data includes specific encoded data where a luminance component is encoded separately from chrominance components; generating monochrome data by decoding the luminance component without decoding the chrominance components if the specific encoded data is detected and execution of the monochrome printing is determined; and executing monochrome printing based on the monochrome data.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram representing a functional configuration of an image forming system 10 according to one embodiment of the disclosure;

FIG. 2 illustrates a flow chart representing an image output process according to a comparative example;

FIG. 3 illustrates a flow chart representing an image output process according to one embodiment; and

FIG. 4 illustrates a table of input postscript print job and execution of monochrome printing.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes embodiments of the disclosure (hereinafter referred to as, the “embodiments”) comparing with a comparative example with reference to the drawings.

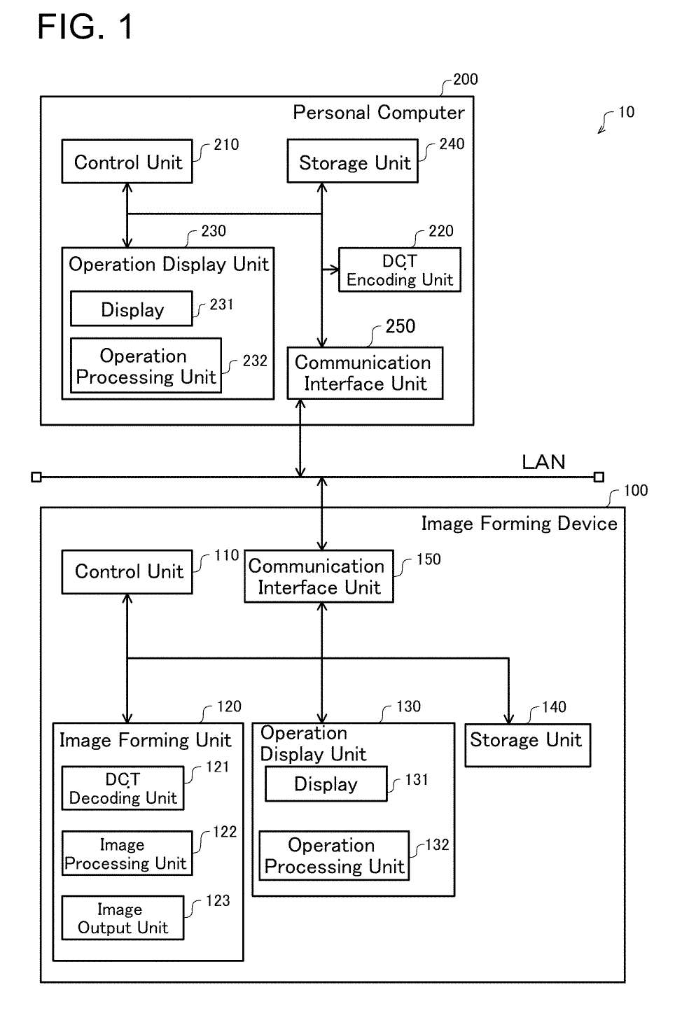

FIG. 1 illustrates a block diagram representing a functional configuration of an image forming system 10 according to one embodiment of the disclosure. The image forming system 10 includes an image forming device 100 and a personal computer 200. The plurality of personal computers 200 is connected to the image forming device 100 via a network (which is a LAN in this example).

The image forming device 100 includes a control unit 110, an image forming unit 120, an operation display unit 130, a storage unit 140, and a communication interface unit 150. The personal computer 200 includes a control unit 210, a DCT encoding unit 220, an operation display unit 230, a storage unit 240, and a communication interface unit 250. The DCT encoding unit 220 encodes image data to generate encoded image data by discrete cosine transform (DCT).

The communication interface unit 150 and the communication interface unit 250 communicate using a Transmission Control Protocol/Internet Protocol (TCP/IP) suite. The communication interface unit 150 functions as a print data receiver in this embodiment. The print data receiver may receive print data via a discrete I/O interface.

The image forming unit 120 includes a DCT decoding unit 121, an image processing unit 122, and an image output unit 123. The DCT decoding unit 121 decodes the encoded image data by inverse discrete cosine transform (IDCT). The image processing unit 122 processes the scan data in accordance with a print setting. The image output unit 123 prints an image on a printing medium based on the decoded print data. The DCT decoding unit 121 and the image processing unit 122 function as a monochrome data generating unit. The image output unit 123 functions as a print executing unit.

The operation display unit 130 of the image forming device 100 includes a display 131 and an operation processing unit 132. The operation display unit 230 of the personal computer 200 includes a display 231 and an operation processing unit 232. The display 131, which functions as a touch panel, displays various menus as a receiving screen. The operation processing units 132 and 232 accept an input operation of a user from the display 131, which functions as a touch panel, and various kinds of buttons and switches (not illustrated).

The input operation includes the print setting of color printing or monochrome printing. If the print setting of monochrome printing is input, the control unit 210 puts command data for commanding execution of monochrome printing into the print data. The print data is a file in PostScript (PS) language, which is one of the Page Description Languages.

The control units 110 and 210 include a main storage unit such as a RAM and a ROM, and a control unit such as a Micro Processing Unit (MPU) and a Central Processing Unit (CPU). The control units 110 and 210 also include a controller function related to an interface such as various kinds of I/Os, a Universal Serial Bus (USB), a bus, and other hardware, and control the entire image forming device 100 and the entire personal computer 200, respectively.

The storage units 140 and 240 are storage devices formed of such as a hard disk drive and a flash memory, which are non-transitory recording mediums, and store control programs and data of processes performed by the control units 110 and 210, respectively.

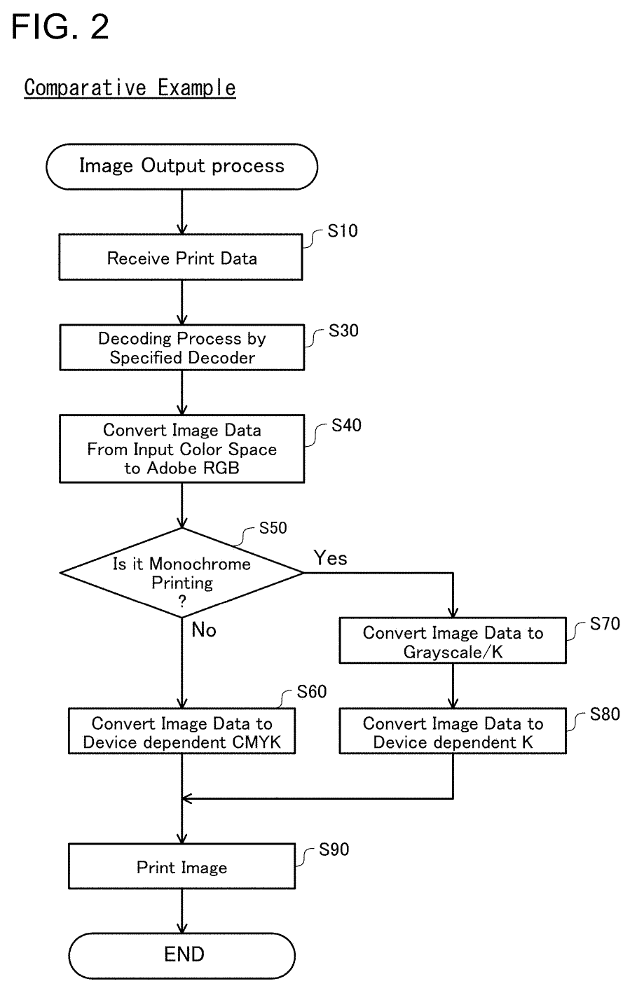

FIG. 2 illustrates a flow chart representing an image output process according to a comparative example. This comparative example is described as one example of an image output process.

At Step S10, the image forming device 100 receives print data from the personal computer 200 using the communication interface unit 250 and the communication interface unit 150. The print data causes the image forming device 100 to perform execution of monochrome printing in this case. The print data includes encoded image data, command data, and color space data.

The encoded image data has been encoded by the DCT encoding unit 220 from image data in a color space of RGB (Adobe (Trade Mark) RGB in this embodiment) or CMYK (Adobe (Trade Mark) CMYK in this embodiment). When the image data is in RGB color space, the DCT encoding unit 220 converts the RGB data into YUV and encodes the YUV data separately into encoded Y data, encoded U data, and encoded V data by discrete cosine transform. When the image data is in CMYK color space, the DCT encoding unit 220 converts the CMYK data into YUVK′ data and encodes the YUVK′ data separately into encoded Y data, encoded U data, encoded V data, and encoded K′ data by discrete cosine transform.

The Y data and K′ data are luminance components while the U data and V data are chrominance components. The DCT encoding unit 220 respectively converts the RGB data and the CMYK data into YUV data and YUVK′ data in order to ensure the efficient compression taking advantage the sensitivity characteristics of human eye. The human eye is less sensitive to chrominance than luminance. The encoded YUV data is also referred as a first encoded data. The encoded YUVK′ data is also referred as a second encoded data.

The command data is a piece of data for commanding the execution of the monochrome printing or color printing. The color space data is a piece of data for indicating the input color space before the process including the discrete cosine transform by the DCT encoding unit 220. This process is also referred to as “specific encoding.”

At Step S30, the DCT decoding unit 121 decodes the encoded image data, which is the encoded YUV data or the encoded YUVK′ data, by inverse discrete cosine transform. The DCT decoding unit respectively decodes all the encoded YUV data or all the encoded YUVK′ data so as to extract the YUV data or the YUVK′ data. If the color space data indicates RGB as the input color space, the DCT decoding unit 121 decodes the encoded YUV data so as to extract the YUV data. If the color space data indicates CMYK as the input color space, the DCT decoding unit 121 decodes the encoded YUVK′ data so as to extract the YUVK′ data.

At Step S40, the image processing unit 122 performs a color conversion process on the YUV data or the YUVK′ data. If the color space data indicates RGB as the input color space, the image processing unit 122 performs a color conversion process on the YUV data, so as to generate the image data in the input color space of RGB. If the color space data indicates CMYK as the input color space, the image processing unit 122 performs a color conversion process on the YUVK′ data, so as to generate the image data in the input color space of CMYK.

At Step S50, the image processing unit 122 reads the command data in the print data. If the command data commands an execution of a color printing, the process proceeds to Step S60. If the command data commands an execution of a monochrome printing, the process proceeds to Step S70.

At Step S60, the image processing unit 122 performs a gamma correction on the color image data in the input color space of RGB or CMYK, so as to generate device dependent color image data for printing with the image output unit 123. The device dependent color image data includes device dependent C data, device dependent M data, device dependent Y data, and device dependent K data.

At Step S70, the image processing unit 122 performs a color conversion process on the image data in the input color space of RGB, so as to generate a Grayscale data/K. The Grayscale data/K represents its luminance of the color image data.

At Step S80, the image processing unit 122 performs a gamma correction on the Grayscale data/K, so as to generate device dependent monochrome data. If the color space data indicates RGB, the image processing unit 122 performs a first gamma correction. If the color space data indicates CMYK, the image processing unit 122 performs a second gamma correction. The first gamma correction is prepared for the RGB input color space. The second gamma correction is prepared for the CMYK input color space.

At Step S90, the image output unit 123 prints the image on print medium. For color printing, the image output unit 123 prints the image based on the device dependent color image data. For monochrome printing, the image output unit 123 prints the image based on the device dependent monochrome image data.

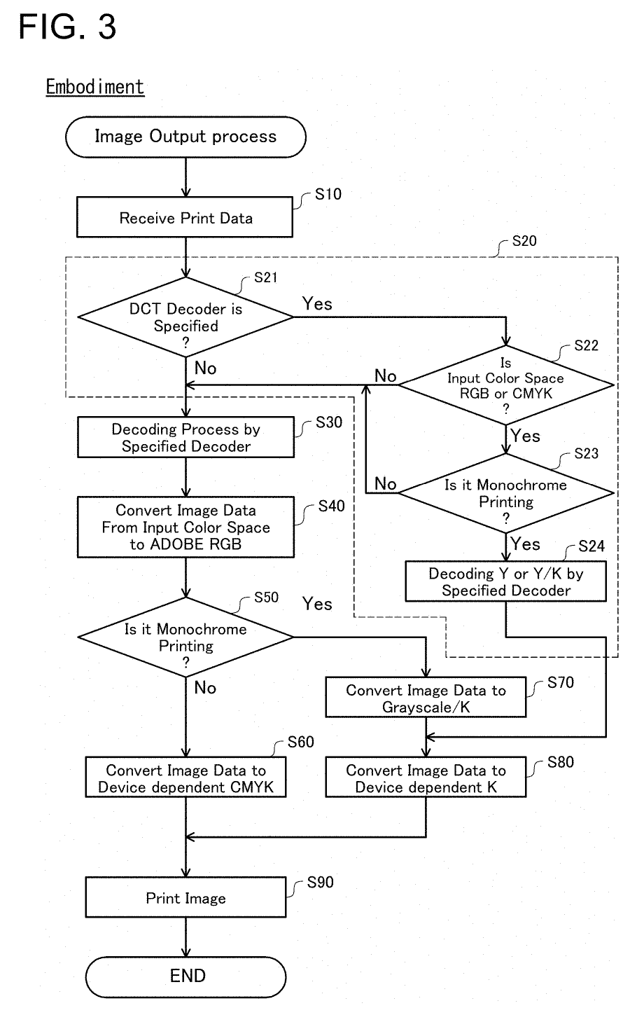

FIG. 3 illustrates a flow chart representing an image output process according to one embodiment. The image output process according to the one embodiment is different from the image output process according to the comparative example in that Step S20, which includes Steps S21 to S24, are added to the image output process according to the comparative example.

At Step S21, the control unit 110 determines whether DCT decoder is specified in the print data. If DCT decoder is specified, the process proceeds to Step S22. If DCT decoder is not specified, the process proceeds to Step S30. The control unit 110 functions as an encoded data detecting unit.

At Step S22, the control unit 110 determines whether the input color space is RGB or CMYK (Adobe RGB or Adobe CMYK in this embodiment) based on the color space data. If the input color space is RGB or CMYK, the process proceeds to Step S23. If the input color space is not RGB nor CMYK, the process proceeds to Step S30.

At Step S23, the image processing unit 122 reads the command data in the print data. If the command data commands an execution of a color printing, the process proceeds to Step S30. If the command data commands an execution of a monochrome printing, the process proceeds to Step S24.

At Step S24, the DCT decoding unit 121 decodes the encoded image data by inverse discrete cosine transform. If the input color space is RGB, the DCT decoding unit decodes the encoded YUV's Y data, which is the luminance component, only so as to directly extract the Y data. If the input color space is CMYK, the DCT decoding unit decodes the encoded YUVK's Y and K data, which are used to generate the luminance component, only so as to extract the Y and K′ data.

At Step S80, the image processing unit 122 performs the gamma correction on the Grayscale data/K prepared for the RGB or CMYK input color space, so as to generate device dependent monochrome data. Specifically, the image processing unit 122 performs the first gamma correction prepared for the RGB input color space if the color space data indicates RGB, and the image processing unit 122 performs the second gamma correction prepared for the CMYK input color space if the color space data indicates CMYK. Then, the image output unit 123 prints the image on print medium (Step S90).

As described above, the image output process according to the one embodiment decodes the encoded Y data only for RGB input color space and decodes the encoded Y and K′ data only for CMYK input color space without decoding the encoded YUV's U and V data, which are the chrominance components. Thus, the image output process according to the one embodiment eliminates the need for decoding the encoded YUV's U and V data, thus ensuring the fast and saved memory compared with the image output process according to comparative example.

### Modification

The disclosure will not be limited to respective embodiments described above, but modifications as follows are also possible.

### Modification 1

While in the above-described embodiment DCT encoding is employed as the encoding method for transferring the print data, any encoding method may be employed insofar as the encoding method encodes a luminance component separately from chrominance components.

### Modification 2

While in the above-described embodiment Postscript is employed as a page description language (PDL), any page description language may be employed insofar as the page description language is able to include the encoded luminance component.

### Modification 3

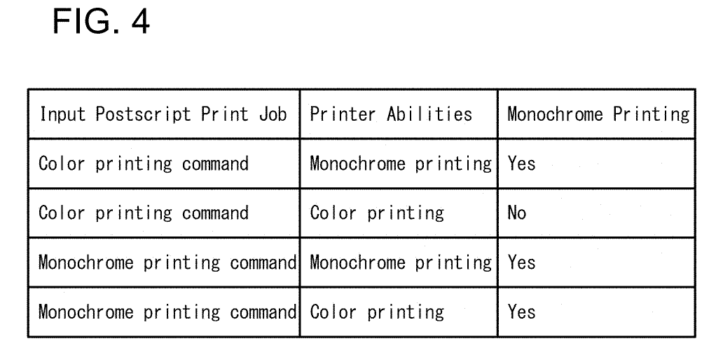

While in the above-described embodiment the image forming device is configured to print color image and monochrome printing, the image forming device may be configured to perform monochrome printing only. In this case, the image forming device performs monochrome printing only, regardless of the command data as illustrated in FIG. 4.

### Modification 4

While in the above-described embodiment the control unit determines whether DCT decoder is specified in the print data, the control unit may have any configuration insofar as the control unit is configured to detect whether the received print data includes specific encoded data where a luminance component is encoded separately from chrominance components.

### Modification 5

While in the above-described embodiment the personal computer puts command data for commanding execution of monochrome printing into the print data and encodes the YUV data or the YUVK′ data, the personal computer may encode the Y data only or the Y and K′ data only.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1: In an image forming system constituted by a personal computer (PC) and an image forming device connected to each other via a communications network, the personal computer including a PC control unit functioning as a discrete cosine transform (DCT) encoding unit for generating, from print data including image data and command data, specified print data including, together with the command data, color space data and encoded image data containing color-space-specified chrominance components together with a color-space-specified luminance component encoded separately from the chrominance components, the image forming device including an image-forming control unit functioning as an encoded data detecting unit, an image processing unit functioning as a monochrome data generating unit, an image output unit functioning as a print executing unit, and an operation display unit for accepting user input of operations including a color/monochrome printing print-setting operation, an image forming method comprising:
accepting through the operation display unit, and network-communicating to the PC, a print-setting operation as to whether the image forming device is to execute color printing or monochrome printing, and in the PC control unit, accordingly putting into the print data command data for commanding execution of color printing or monochrome printing in the image forming device;
receiving, in the image forming device, print data from the personal computer via the communications network;
reading, in the image processing unit, the command data in the print data to determine whether monochrome printing is commanded;
detecting, in the encoded data detecting unit, whether the received print data is the specified print data including encoded image data containing a color-space-specified luminance component encoded separately from the chrominance components;
generating, in the monochrome data generating unit, monochrome data by decoding the luminance component alone, without decoding the chrominance components, if the received print data is detected to be the specified print data and the command data in the specified print data is determined to command execution of monochrome printing; and
executing, in the image output unit, monochrome printing based on the monochrome data generated in the monochrome data generating unit.

2: The image forming method according to claim 1, wherein the generating includes generating the monochrome data by inverse discrete cosine transform.

3. (canceled)

4: The image forming method according to claim 1, wherein:
the encoded image data is one of first encoded image data representing the luminance component using Y component and second encoded image data representing the luminance component using Y and K components; and
the generating includes decoding the Y component as the luminance component if the color space data indicates RGB, and decoding the Y and K components as the luminance component if the color space data indicates CMYK.

5: The image forming method according to claim 4, wherein
the generating includes generating device dependent monochrome data by execution of a first gamma correction if the color space data indicates RGB, and generating device dependent monochrome data by execution of a second gamma correction if the color space data indicates CMYK.

6: An image forming system comprising:
a personal computer (PC) and an image forming device connected to each other via a communications network;
the personal computer including
a PC control unit functioning as a discrete cosine transform (DCT) encoding unit for generating, from print data including image data and command data for commanding execution of color printing or monochrome printing in the image forming device, specified print data including, together with the command data, color space data and encoded image data containing color-space-specified chrominance components together with a color-space-specified luminance component encoded separately from the chrominance components; and
the image forming device including
an operation display unit for accepting, and network-communicating to the PC, user input of operations including a color/monochrome printing print-setting operation as to whether the image forming device is to execute color printing or monochrome printing,
a print data receiver configured to receive print data from the personal computer via the communications network,
an image-forming control unit functioning as an encoded data detecting unit configured to detect whether the received print data is the specified print data including encoded data containing a color-space-specified luminance component encoded separately from the chrominance components,
an image processing unit for reading the command data in the print data to determine whether monochrome printing is commanded, and functioning as a monochrome data generating unit configured to generate monochrome data by decoding the luminance component alone, without decoding the chrominance components, if the received print data is detected to be the specified print data and the command data in the specified print data is determined to command execution of monochrome printing, and
an image output unit functioning as a print executing unit configured to execute monochrome printing based on the monochrome data generated in the monochrome data generating unit.

7: The image forming system according to claim 6, wherein the monochrome data generating unit is configured to generate the monochrome data by inverse discrete cosine transform.

8. (canceled)

9: The image forming system according to claim 6, wherein:
the encoded image data is one of first encoded image data representing the luminance component using Y component and second encoded image data representing the luminance component using Y and K components; and
the monochrome data generating unit is configured to decode the Y component as the luminance component if the color space data indicates RGB, and decode the Y and K components as the luminance component if the color space data indicates CMYK.

10: The image forming system according to claim 9, wherein
the monochrome data generating unit is configured to generate device dependent monochrome data by execution of a first gamma correction if the color space data indicates RGB, and generate device dependent monochrome data by execution of a second gamma correction if the color space data indicates CMYK.

11: A non-transitory computer-readable recording medium storing an image forming program to control an image forming device, in an image forming system constituted by a personal computer (PC) and the image forming device connected to each other via a communications network, the personal computer including a PC control unit functioning as a discrete cosine transform (DCT) encoding unit for generating, from print data including image data and command data, specified print data including, together with the command data, color space data and encoded image data containing color-space-specified chrominance components together with a color-space-specified luminance component encoded separately from the chrominance components, the image forming device including an operation display unit for accepting, and network-communicating to the PC, user input of operations including a color/monochrome printing print-setting operation as to whether the image forming device is to execute color printing or monochrome printing, the image forming program causing the image forming device to function as:
a print data receiver configured to receive print data from the personal computer via the communications network;
an image-forming control unit functioning as an encoded data detecting unit configured to detect whether the received print data is the specified print data including encoded data containing a color-space-specified luminance component encoded separately from the chrominance components;
an image processing unit for reading the command data in the print data to determine whether monochrome printing is commanded, and functioning as a monochrome data generating unit configured to generate monochrome data by decoding the luminance component alone, without decoding the chrominance components, if the received print data is detected to be the specified print data and the command data in the specified print data is determined to command execution of monochrome printing; and
an image output unit functioning as a print executing unit configured to execute monochrome printing based on the monochrome data generated in the monochrome data generating unit.

12: The recording medium according to claim 11, wherein the monochrome data generating unit is configured to generate the monochrome data by inverse discrete cosine transform.

13. (canceled)

14: The recording medium according to claim 11, wherein:
the encoded image data is one of first encoded image data representing the luminance component using Y component and second encoded image data representing the luminance component using Y and K components; and
the monochrome data generating unit is configured to decode the Y component as the luminance component if the color space data indicates RGB, and decode the Y and K components as the luminance component if the color space data indicates CMYK.

15: The recording medium according to claim 14, wherein the monochrome data generating unit is configured to generate device dependent monochrome data by execution of a first gamma correction if the color space data indicates RGB, and generate device dependent monochrome data by execution of a second gamma correction if the color space data indicates CMYK.
